(19) United States
(12) Patent Application Publication
(10) Pub. No.: US 2026/0019989 A1
(43) Pub. Date: Jan. 15, 2026

(54) Method and Apparatus for Locating an Electronic Device in or at a Motor Vehicle

(71) Applicant: Bayerische Motoren Werke Aktiengesellschaft, Muenchen (DE)

(72) Inventors: Walter BRONZI, Mountain View, CA (US); Elin ERIKSSON, Ottobrunn (DE)

(21) Appl. No.: 19/260,945

(22) Filed: Jul. 7, 2025

(30) Foreign Application Priority Data
Jul. 12, 2024 (DE) 10 2024 119 983.0

(51) Int. Cl. H04W 64/00; H04W 4/40; H04W 4/80

(52) U.S. Cl. CPC H04W 64/006; H04W 4/40; H04W 4/80

(57) ABSTRACT

An apparatus is configured to locate an electronic device in or at a vehicle. The apparatus uses a phase-based distance determination method to determine M distance values for the distance of the electronic device from applicable M communication units of the vehicle, where M is greater than two. The apparatus determines position information relating to the position of the electronic device relative to the vehicle based on the M distance values.

### CROSS REFERENCE TO RELATED APPLICATION

This application claims priority under 35 U.S.C. § 119 from German Patent Application No. 10 2024 119 983.0, filed Jul. 12, 2024, the entire disclosure of which is herein expressly incorporated by reference.

### BACKGROUND AND SUMMARY

The invention relates to a method and a corresponding apparatus for locating a device in or in the surroundings of a motor vehicle.

A vehicle may have one or more functions that can be controlled by a user of the vehicle using an electronic device, e.g. a smartphone. Furthermore, a user can be provided with the opportunity to use a wireless communication connection, in particular a BLE (Bluetooth Low Energy) communication connection, between the vehicle and the electronic device to integrate an electronic device into a user interface of the vehicle.

Control of the one or more vehicle functions and/or operation of the electronic device may depend on the position of the device relative to the vehicle. This document is concerned with the technical object of permitting particularly precise location of an electronic device, in particular a BLE-compatible device, in or at a vehicle.

The object is achieved by the aspects, features, functions and/or principles of embodiments described herein. It is pointed out that additional features of a patent claim dependent on an independent patent claim, without the features of the independent patent claim or in combination only with a subset of the features of the independent patent claim, may form a standalone invention that is independent of the combination of all of the features of the independent patent claim and may be made into the subject matter of an independent claim, a divisional application or a subsequent application. This applies in the same way to technical teachings that are described in the description and may form an invention independent of the features of the independent patent claims.

According to one aspect, an apparatus for locating an electronic, in particular BLE-compatible, (user) device (e.g. a smartphone or a smart device or headphones or a game controller) in or at a (motor) vehicle is described. The apparatus is configured to use a phase-based distance determination method, in particular a BLE channel sounding procedure, to determine M distance values for the distance of the electronic device from applicable M communication units of the vehicle, with M≥2, in particular M≥3.

The apparatus may be configured to cause M wireless communication connections to be set up, in particular sequentially or in parallel or simultaneously, between the electronic device and the applicable M communication units of the vehicle. The M distance values can be determined using the applicable M wireless communication connections and in each case using a phase-based distance determination method. As a preference, each of the M wireless communication connections comprises a Bluetooth Low Energy (BLE) communication connection. Furthermore, as a preference, the phase-based distance determination method comprises, in particular is, BLE channel sounding.

The apparatus is furthermore configured to determine position information relating to the position of the electronic device relative to the vehicle based on the M distance values. A triangulation method can be used for this purpose. Alternatively or additionally, a machine-learning-based method can be used to determine the position information based on the M distance values. The position information may comprise a coordinate of the position of the electronic device e.g. for each of one or more different axes of the coordinate system of the vehicle (e.g. the longitudinal axis, the transverse axis and/or the vertical axis). Alternatively or additionally, the position information can indicate the distance, the azimuth angle and/or the elevation angle of the position of the electronic device for a polar coordinate system of the vehicle.

The apparatus may be configured to permit operation of the electronic device in conjunction with the vehicle on the basis of the position information. The apparatus may e.g. be configured to take the position information as a basis for defining one or more vehicle functions of the vehicle that can be controlled by way of the electronic device. Alternatively or additionally, the apparatus may be configured to define the scope of operation of the electronic device (in conjunction with the vehicle) on the basis of the position information.

The use of a phase-based distance determination method permits the distance values to be determined in a precise and robust manner, permitting precise location of the electronic device in or at a vehicle.

The vehicle can have a number of different spatial zones. Examples of zones are a zone in the driver's position, a zone in the front seat passenger's position and/or one or more zones on a rear seat of the vehicle. The apparatus may be configured to take the position information as a basis for determining which of the zones of the vehicle the electronic device is in. The one or more vehicle functions can then be operated on the basis of the determined zone. This permits particularly robust position-dependent control of vehicle functions.

The apparatus may be configured to take sensor data of at least one sensor of the vehicle as a basis for detecting a location situation for locating an electronic device. As a preference, the at least one sensor comprises
at least one door sensor designed to acquire sensor data relating to the opening and/or closing of a door of the vehicle; and/or
at least one occupancy sensor designed to acquire sensor data relating to whether or not an occupant position, in particular a seat, in the vehicle is occupied; and/or
at least one (interior) camera configured to acquire sensor data relating to one or more occupant positions in the vehicle.

The vehicle may comprise a door sensor for each of different doors of the vehicle. Alternatively or additionally, the vehicle may comprise an occupancy sensor for each of different occupant positions.

The apparatus may be configured to take sensor data of the at least one sensor of the vehicle as a basis for detecting that
a door of the vehicle has been opened or closed; and/or.
the state of occupancy of an occupant position in the vehicle has changed.

In particular, it can be determined which door has been opened or closed and/or for which occupant position the state of occupancy has changed.

Detection can be taken as a basis for ascertaining that a location situation applies.

The apparatus may be configured to determine the M distance values for the distance of the electronic device from the applicable M communication units of the vehicle selectively in response to a detected location situation. In other words, the M distance values for the distance of the electronic device from the applicable M communication units of the vehicle can be selectively determined (only) after a location situation has been detected. This allows for particularly efficient location of an electronic device.

The apparatus may be configured to take sensor data of the at least one sensor of the vehicle as a basis for determining an estimation position at which the electronic device is expected to be arranged. The estimation position may comprise, in particular be, a specific occupant position from a plurality of different occupant positions in the vehicle. By way of example, it is possible to detect which door has been opened or closed and/or for which occupant position the state of occupancy has changed. This can be taken as a basis for determining the estimation position, in particular the occupant position, at which the electronic device is expected to be arranged.

The apparatus may be configured to determine the M distance values for the distance of the electronic device from the applicable M communication units of the vehicle on the basis of the estimation position. The apparatus may in particular be configured to select the M communication units of the vehicle from a total number of communication units of the vehicle on the basis of the estimation position. Alternatively or additionally, the apparatus may be configured to adapt operation of the M communication units of the vehicle for determining the applicable M distance values on the basis of the estimation position. This allows for particularly efficient and precise location of the electronic device.

Another aspect describes a (road) motor vehicle (in particular a passenger vehicle or a commercial vehicle or a bus or a motorcycle) that comprises the apparatus described in this document.

According to another aspect, a method for locating an electronic device in or at a (motor) vehicle is described. The method comprises using a phase-based distance determination method to determine M distance values for the distance of the electronic device from applicable M communication units of the vehicle, with M≥2, in particular M≥3. In addition, the method comprises determining position information relating to the position of the electronic device relative to the vehicle based on the M distance values. The position information can e.g. indicate (in polar coordinates) the distance, the azimuth angle and/or the elevation angle of the device relative to a reference point of the vehicle.

It should be noted that the aspects described in connection with the apparatus, in particular the claims described in connection with the apparatus, can also be applied as corresponding method features to the method.

Another aspect describes a software (SW) program. The SW program can be configured to be executed on a processor and to thereby carry out the method described in this document.

Another aspect describes a storage medium. The storage medium may comprise an SW program that is configured to be executed on a processor and thereby to carry out the method described in this document.

It should be noted that the methods, apparatuses and systems described in this document may be used both on their own and in combination with other methods, apparatuses and systems described in this document. Furthermore, any aspects of the methods, apparatuses and systems described in this document may be combined with one another in a wide variety of ways. The features of the claims may in particular be combined with one another in a wide variety of ways. Furthermore, features in parentheses should be understood as optional features.

The invention is described in more detail below with reference to exemplary embodiments. Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1a shows an illustrative digital entry system of a vehicle;

FIG. 1b shows an illustrative usage situation for a digital entry system;

FIG. 2 shows illustrative sensors of a vehicle; and

FIG. 3 shows a flowchart of an illustrative method for locating an electronic device in or at a vehicle.

### DETAILED DESCRIPTION OF THE DRAWINGS

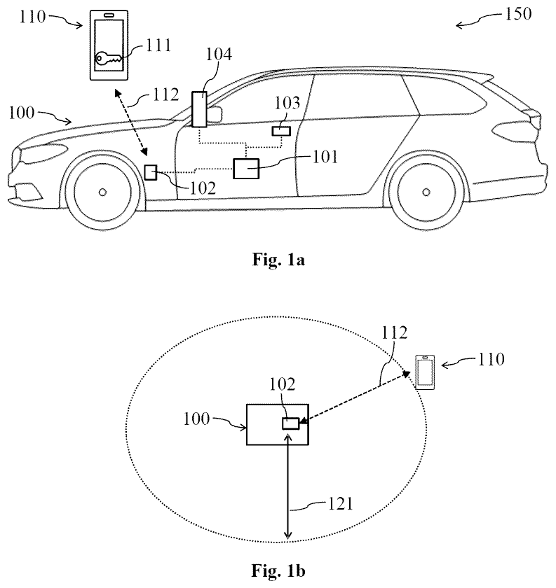

As stated at the outset, this document is concerned with precise location of an electronic device in and/or at a vehicle. In this context, FIG. 1a shows an illustrative (entry) system 150 that comprises at least one vehicle 100 and a digital key device 110. The digital key device 110 is typically a portable electronic (user) device, e.g. a smartphone or a tablet PC, wherein a digital key 111 is stored on the portable electronic device. The digital key 111 may be stored in a protected memory area, in particular in what is known as a “secure element”, of the portable electronic device.

The digital key device 110 is designed to communicate with a communication unit 102 of the vehicle 100 over one or more different wireless communication connections 112. The different communication connections 112 can be used for different purposes. In particular, a Bluetooth Low Energy (BLE) communication connection 112 can be used to
determine the distance and/or relative position between the digital key device 110 and the vehicle 100 (in particular on the basis of the signal strength, in particular the RSSI (Received Signal Strength Indicator), of the radio signals interchanged between the vehicle 100 and the device 110; and/or using BLE channel sounding (mode 2/phase-based measurements)); and/or
interchange data between the digital key device 110 and the vehicle 100 (for example a control command for controlling a vehicle function 103, such as the unlocking of a door and/or the opening or closing of a window and/or the activation or deactivation of a heating function and/or the activation or deactivation of the drive motor of the vehicle 100).

A (control) apparatus 101 of the vehicle 100 may be designed to control at least one vehicle function 103 of the vehicle 100 on the basis of the communication between the device 110 and the vehicle 100, as illustrated in FIG. 1b for example. In this context, the digital key 111 of the device 110 can be verified, in particular authenticated. Furthermore, after successful authentication, one or more vehicle functions 103 can be controlled, in particular on the basis of
the distance between the device 110 and the vehicle 100;
the position of the device 110 relative to the vehicle 100; and/or.
a control command that is sent from the device 110 to the vehicle 100 over a communication connection 112.

In an illustrative system 150, a BLE communication connection 112 can be established between the device 110 and the vehicle 100 as soon as the distance between the device 110 and the vehicle 100 is equal to or less than a first distance threshold value 121. This allows the user to remotely control one or more vehicle functions 103 using the device 110. Typically, the vehicle 100 repeatedly indicates, e.g. at a specific frequency, the availability of a BLE communication connection 112. From the first distance threshold value 121, the device 110 (which may also be referred to as “user equipment” (UE)) receives the display message of the vehicle 100 and the BLE communication connection 112 can then be established between the device 110 and the vehicle 100. The first distance threshold value 121 may depend on the communication capabilities of the device 110, the environment of the vehicle 100 and/or of the device 110, and/or the position of the device 110 relative to the vehicle 100.

As already explained earlier, the distance between a first communication unit 110 (e.g. the key device) and a second communication unit 102 (e.g. the vehicle 100) can be determined using BLE channel sounding. In the context of BLE channel sounding, one of the two communication units 110, 102 is what is known as the initiator and the other communication unit 110, 102 is what is known as the reflector. The initiator sends an initiator signal having a specific amplitude over a specific BLE channel. The specific BLE channel is associated with a specific frequency of the initiator signal. The reflector measures the phase of the received initiator signal. Furthermore, the reflector returns a reflector signal to the initiator on the same BLE channel, the reflector signal, on being sent, having the measured phase of the received initiator signal.

The initiator measures the phase of the received reflector signal and compares it with the phase of the originally sent initiator signal. The phase difference between the phase of the received reflector signal and the phase of the originally sent initiator signal depends on the distance travelled by each of the two signals (the distance travelled corresponding to twice the distance between the two communication units 110, 102).

The above-mentioned phase measurement can be performed for a large number of different BLE channels, i.e. for a large number of different frequencies. Based on the large number of measured phase differences for the corresponding large number of different BLE channels (e.g. N=72 different BLE channels), a measured value for the distance between the two communication units 110, 102 can be determined in a precise manner.

The phase of the received reflector signal can be determined using an in-phase & quadrature (IQ for short) method. For this purpose, the received reflector signal is overlaid with an in-phase reference signal having the specific frequency of the respective BLE channel in order to determine the I coordinate of an IQ data point. Furthermore, the received reflector signal is overlaid with a quadrature phase reference signal having the specific frequency of the respective BLE channel (the quadrature phase reference signal having a 90° phase shift compared to the in-phase reference signal) in order to determine the Q coordinate of the IQ data point.

The IQ data point for a BLE channel can be represented as a point in the (Cartesian) IQ coordinate system. In a corresponding manner, IQ data points can be determined for the N different BLE channels (i.e. for N different frequencies), and can each be represented as a point in the IQ coordinate system. Each of the individual IQ data points has an amplitude and a phase (in polar coordinates). The phase corresponds to the phase difference to be determined Δθ.

The following relationship can be deduced between the phase difference Δθₙ, the measured value of the distance D and the frequency fₙ of the respective BLE channel n, with n=1, . . . , N,

$${Δθ}_{n} = 2 π \frac{2 {Df}_{n}}{c}$$

where c is the speed of light. There is therefore a linear relationship between the phase difference Δθₙ and the frequency fₙ of the respective BLE channel n.

BLE channel sounding can therefore be used to determine the distance D (i.e. a distance value for the distance) between an electronic (user) device 110 and a communication unit 102 of the vehicle 100 in a precise manner.

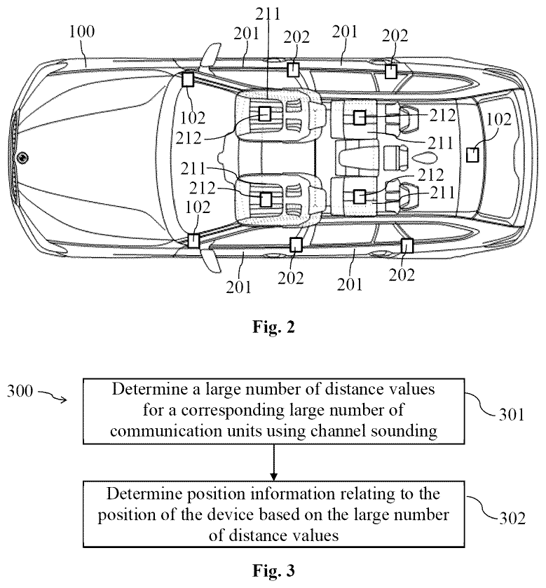

FIG. 2 shows illustrative sensors of a vehicle 100 that are able to be used to determine the position of a device 110 in or at the vehicle 100. The vehicle 100 may comprise multiple communication units 102 arranged at different places in the vehicle 100, e.g. in the front area, in the rear area, on the driver's side and/or on the passenger's side. In the example shown, the vehicle 100 has three different communication units 102 (two in the front area and one in the rear area of the vehicle 100).

The distance value of the distance between the device 110 and the respective communication unit 102 can be determined (using BLE channel sounding) for each of the M different communication units 102 (in particular M≥3). Based on the M distance values and based on the position of the M different communication units 102, the position of the device 110 can be determined (using a triangulation method) in a precise manner. The position of the device 110 can be specified in the (Cartesian or polar) coordinate system of the vehicle 100.

The vehicle 100 can have multiple different occupant positions 211. A vehicle seat for an occupant may be arranged at each of the individual occupant positions 211. For each of the individual occupant positions 211, the vehicle 100 can have an occupancy sensor 212 designed to detect whether or not there is an occupant at the respective occupant position 211.

The apparatus 101 of the vehicle 100 may be designed to take the sensor data of the occupancy sensors 212 of the individual occupant positions 211 as a basis for
determining whether or not there is an occupant at the respective occupant position 211; and/or
detecting a time at which an occupant position 211 is occupied by an occupant, or at which an occupant position 211 becomes vacant.

The vehicle 100 may comprise multiple vehicle doors 201 that permit occupants to get to the individual occupant positions 211, or to leave the individual occupant positions 211. For each of the individual doors 201, the vehicle 100 may comprise a door sensor 202 that detects when the respective door 201 is being opened or closed.

The apparatus 101 of the vehicle 100 may be configured to take the sensor data of the door sensors 202 of the individual doors 201 of the vehicle 100 as a basis for detecting that a door 201 is being opened or closed. This can be taken as a basis (in conjunction with the sensor data from one or more occupancy sensors 212) for concluding that an occupant at a specific occupant position 211 is getting into the vehicle 100 or getting out of the vehicle 100.

The apparatus 101 may in particular be configured to determine the position of an electronic device 110 in or at a vehicle 100,
based on M distance values for M different (and differently positioned) communication units 112 of the vehicle 100;
based on the sensor data from one or more door sensors 202; and/or.
based on the occupancy sensors 212 of one or more occupant positions 211 in the vehicle 100.

This allows the position of the device 110 to be determined in a particularly precise and efficient manner.

Thus, a vehicle 100 is described that has one or more communication units 102. Each communication unit 102 has one or more antennas. Each of the individual communication units 102 may be designed to use channel sounding, in particular BLE channel sounding, to determine the distance value of the distance of the respective communication unit 102 from an electronic device 110. The antennas of the one or more communication units 102 may be arranged inside and/or outside the vehicle 100. The determined distance values of the distance from the M different communication units 102 and/or antennas can be taken as a basis for effecting location of a device 110. Location of a device 110 inside and outside the vehicle 100 can be effected on the basis of a location unit that has previously been trained (by machine learning).

As already explained, distance measurement and/or location can be effected by way of Bluetooth channel sounding (or by way of channel sounding in general), which uses phase-based distance measurement and provides the distance between a communication unit 102 and/or an antenna and a device 110.

Multiple algorithms can be used for determining the exact position and/or region of a device 110 inside or outside a vehicle 100.

The apparatus 101 of the vehicle 100 may be configured to detect the approach (or the probability of approach) of a person (carrying a device 110) in or outside the vehicle 110. This can be done by aggregating various sensors 102, 202, 212 of the vehicle 100 (e.g. door sensor 202, occupancy sensor 212, and/or camera). Furthermore, the apparatus 101 of the vehicle 100 may be configured to take one or more communication connections 112 as a basis for detecting a device 110 that is close to or in the vehicle 100.

A device 110 can be detected (based on a communication connection 112). Information relating to the type of device 110 can also be determined. Furthermore, information relating to an occupant and/or relating to the state of occupancy of one or more occupant positions 211 in the vehicle 100 can be determined (e.g. which door is open, in which seat someone is sitting, what the interior camera can detect, etc.). Location of the device 110 (using channel sounding) can be started selectively, e.g. when a change in the state of occupancy of the vehicle 100 is detected (e.g. using a door sensor 202, using an occupancy sensor 212 and/or using a camera of the vehicle 100), i.e. when a location situation is detected. This can reduce complexity, optimize vehicle architecture, provide more accurate results and/or improve resource utilization.

For example, it is possible to detect that
a specific door 201 is being opened;
the occupancy sensor 212 for a specific occupant position 211 is being triggered; and/or
the camera detects an occupant at the specific occupant position 211.

If necessary, the (BLE) communication connection 112 between a device 110 and a communication unit 102 can be used to determine the type of device 110 (headphones).

It can be assumed that the detected device 110 is carried by the occupant at the specific occupant position 211 (e.g. at the front seat passenger's position). Location of the device 110 can then be optimized for location at the specific occupant position 211 (e.g. by adapting the one or more communication units 102 and/or by adapting operation of the one or more communication units 102). Alternatively or additionally, the detected device 110 can be assigned to the specific occupant position 211. Alternatively or additionally, operation of the detected device 110 can be adapted (e.g. in regard to the scope of use) for the specific occupant position 211.

FIG. 3 shows a flowchart of an illustrative (possibly computer-implemented) method 300 for locating an electronic (user) device 110, such as a smartphone, in or at a (motor) vehicle 100. The method 300 can be carried out by a (control) apparatus 101 of the vehicle 100.

The method 300 comprises using a phase-based distance determination method, in particular using BLE channel sounding, to determine 301 M distance values for the distance of the electronic device 110 from applicable M communication units 102 of the vehicle 100, with M≥2, in particular M≥3. For this purpose, M communication connections 112 can be set up (sequentially or simultaneously) between the device 110 and the applicable M communication units 102 of the vehicle 100.

The method 300 furthermore comprises determining 302 position information relating to the position of the electronic device 110 relative to the vehicle 100 based on the M distance values. A triangulation method can be used for this purpose.

The use of a phase-based distance determination method, in particular BLE channel sounding, for determining the M distance values permits particularly precise and robust location of an electronic device 110 in or at a vehicle 100.

The present invention is not restricted to the exemplary embodiments that are shown. It should in particular be noted that the description and the figures are intended to illustrate the principle of the proposed methods, apparatuses and systems only by way of example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus for locating an electronic device in or at a vehicle, the apparatus comprising:
a non-transitory computer-readable medium storing software; and
a processor configured via the software to:
use a phase-based distance determination method to determine M distance values for the distance of the electronic device from applicable M communication units of the vehicle, wherein M is greater than two; and
determine position information relating to a position of the electronic device relative to the vehicle based on the M distance values.

2. The apparatus of claim 1, wherein the processor is further configured to:
cause M wireless communication connections to be set up between the electronic device and the applicable M communication units of the vehicle; and
determine the M distance values using the applicable M wireless communication connections, for each and in each case using a phase-based distance determination method.

3. The apparatus of claim 2,
wherein each of the M wireless communication connections comprises a Bluetooth Low Energy (BLE) communication connection; and
wherein the phase-based distance determination method comprises BLE channel sounding.

4. The apparatus of claim 1, wherein the processor is further configured to take the position information as a basis for:
permitting operation of the electronic device in conjunction with the vehicle; and
defining one or more vehicle functions of the vehicle that can be controlled via the electronic device, and/or a scope of operation of the electronic device.

5. The apparatus of claim 1, wherein the processor is further configured to:
take sensor data of at least one sensor of the vehicle as a basis for detecting a location situation for locating an electronic device; and
determine the M distance values for the distance of the electronic device from the applicable M communication units of the vehicle selectively in response to the detected location situation.

6. The apparatus of claim 5, wherein the at least one sensor comprises:
a door sensor configured to acquire sensor data relating to the opening and/or closing of a door of the vehicle;
an occupancy sensor configured to acquire sensor data relating to whether a seat in the vehicle is occupied; and/or
a camera configured to acquire sensor data relating to one or more occupant positions in the vehicle.

7. The apparatus of claim 5, wherein the processor is further configured to:
take sensor data of at least one sensor of the vehicle as a basis for detecting that: a door of the vehicle has been opened/closed, and/or a state of occupancy of an occupant position in the vehicle has changed; and
take the detection as a basis for detecting the location situation.

8. The apparatus of claim 5, wherein the processor is further configured to:
take sensor data of at least one sensor of the vehicle as a basis for determining an estimation position at which the electronic device is expected to be; and
determine the M distance values for the distance of the electronic device from the applicable M communication units of the vehicle based on the estimation position.

9. The apparatus of claim 8, wherein the processor is further configured to:
select the M communication units from a total number of communication units of the vehicle based on the estimation position; and/or
adapt operation of the M communication units for determining the applicable M distance values based on the estimation position.

10. A method for locating an electronic device in or at a vehicle, comprising:
using a phase-based distance determination method to determine M distance values for the distance of the electronic device from applicable M communication units of the vehicle, wherein M is greater than two; and
determining position information relating to a position of the electronic device relative to the vehicle based on the M distance values.
